(19) United States
(12) Patent Application Publication
(10) Pub. No.: US 2025/0128332 A1
(43) Pub. Date: Apr. 24, 2025

(54) INERT GAS PURGING SYSTEM FOR ADDITIVE MANUFACTURING SYSTEMS AND RELATED METHODS

(71) Applicant: Blue Origin LLC, Kent, WA (US)

(72) Inventors: Steven James Craigen, Auburn, WA (US); Michael J. Panzarella, Seattle, WA (US)

(21) Appl. No.: 18/490,653

(22) Filed: Oct. 19, 2023

(51) Int. Cl. B22F 12/70; B22F 10/28; B33Y 10/00; B33Y 30/00

(52) U.S. Cl. CPC B22F 12/70; B33Y 10/00; B33Y 30/00; B22F 10/28

(57) ABSTRACT

Additive manufacturing systems and associated methods are disclosed herein. In some embodiments, the additive manufacturing system includes a build chamber that has active build region, a support platform positioned in the active build region, a recoater arm, and a chamber-purging system. The recoater arm is movable in a lateral direction along a travel path above the active build region to spread a powder over the active build region. The chamber-purging system includes extendable input and return channels that are movable between a first position outside the travel path and a second position at least partially within the travel path.

### TECHNICAL FIELD

The present technology is directed generally to systems and methods for additive manufacturing, including systems and methods for purging an additive manufacturing system.

### BACKGROUND

Additive manufacturing, also commonly referred to as 3D printing, includes depositing layers of material to create a three-dimensional object. These techniques have found a wide variety of applications and can be used to produce objects of nearly any shape, based on data from a three-dimensional, computer-generated model.

In a typical powder bed additive manufacturing process, a thin layer of a powder is spread over a build surface using a recoater arm. A laser or other energy beam follows a computer-generated path over the powder to melt and solidify the powder only in areas corresponding to a planned build object on any given layer. Then an additional layer of powder is laid upon the first layer, and the laser again solidifies the target portions of powder. Successively sintering the powder layers melts and joins the layers together to build up the planned build object. Accordingly, this process is repeated until the complete object is manufactured.

For each layer of the build, the consistency of the thickness of the new layer of powder, the quality of the underlying portions of the build object (e.g., previously sintered layers), and the quality of the powder (absence and/or presence of clumps, non-powder material, and/or other contaminants) can each affect the quality of the new layer being sintered. For example, contaminants in the new powder layer can cause errors in the melt pool for the new layer and/or prevent the new layer from properly sintering to a previous layer. However, the sintering process itself introduces contaminants (e.g., smoke) as a byproduct. Accordingly, a typical additive manufacturing system purges the build chamber after sintering each layer to reduce the amount of contaminants within the build chamber. While the foregoing systems and processes are suitable for producing a wide variety of objects, there remains a need for improving the reduction of impurities introduced for each layer.

### BRIEF DESCRIPTION OF THE DRAWINGS

FIGS. 1A-1C are partially schematic, partially cross-sectional views of an additive manufacturing system at various stages of a build process in accordance with some embodiments of the present technology.

FIG. 2 is a side view of a portion of a chamber-purging system configured in accordance with some embodiments of the present technology.

FIGS. 3A and 3B are isometric front and rear views, respectively, of a chamber-purging system configured in a retracted position in accordance with some embodiments of the present technology.

FIGS. 3C and 3D are isometric front and rear views, respectively, of a chamber-purging system configured in an extended position in accordance with some embodiments of the present technology.

FIG. 4 is a flow diagram of a process for operating an additive manufacturing system in accordance with further embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations are shown by way of example in the drawings and are described in detail below. The intention, however, is not to limit the technology to the particular implementations described.

### DETAILED DESCRIPTION

### Overview

Additive manufacturing systems, and associated methods, are disclosed herein. The additive manufacturing systems can include a build chamber that has an active build region, a support platform, an energy beam source, a recoater arm, and a chamber-purging system. The support platform is positioned in the active build region and movable in a travel direction having upward and downward components. The energy beam source is positioned above the active build region to direct an energy beam at the active build region during a build process. The recoater arm is positioned in the build chamber and is movable in a lateral direction along a travel path over the active build region. The recoater arm spreads a layer of a powder over the active build region as it moves along the travel path. The layer of powder can be targeted by the energy beam source based on a plan for a build object. The chamber-purging system is positioned in the build chamber and includes one or more components that are movable between a first position outside the travel path and a second position at least partially within the travel path.

For example, the chamber-purging system can include an extendable supply channel (e.g, that has one or more supply ports (also referred to herein as input nozzles) and/or an extendable return channel having one or more return ports (also referred to herein as suction receivers). The extendable supply channel is fluidly couplable to a source of an inert gas to deliver gas to the build chamber and the telescoping return channel is fluidly couplable to a vacuum component to remove gas from the build chamber. The extendable supply channel is movable between a first retracted state and a first extended state to move the supply port(s) between the first position and the second position to position the supply port(s) in the travel path and adjacent to the active build region. The extendable return channel is movable between a second retracted state and a second extended state to move the return port between the first position and the second position to position the return ports in the travel path and adjacent to the active build region. The supply port(s) and the return ports can establish a flow path for the inert gas that is introduced to the build chamber. By moving the supply port(s) and the return ports into the second position, the chamber-purging system can help improve the purging ability of the flow path during a sintering process, thereby improving the number of byproducts of the sintering process (e.g., smoke and other contaminants) that are removed from the build chamber.

In some embodiments, the chamber-purging system further includes sidewalls extending along lateral sides of the flow path to impede a flow of the gas away from the flow path. As a result, the sidewalls can improve the likelihood that gas in the flow path is captured by the return ports, in turn helping improve the likelihood that the byproduct contaminants are removed, rather than spread. Additionally, or alternatively, the sidewalls can improve the laminarity of the gas in the flow path, which in turn helps improve the number (or volume) of the byproducts that are carried out in the flow path.

In some embodiments, the chamber-purging system further includes a backwall operably coupled to the return port and/or the telescoping return channel. The backwall can move with the return port as the telescoping return channel expands, so as to be positioned behind the return port during operation. In this position, the backwall can impede the flow of the gas away from (and/or out of) the flow path. As a result, similar to the sidewalls, the backwall can improve the likelihood that gas in the flow path is captured by the return ports to help increase the number of the byproduct contaminants that are removed from the build chamber. Additionally, or alternatively, the backwall can improve the laminarity of the gas in the flow path, thereby helping increase the number of the byproducts that are carried out in the flow path.

In some embodiments, the extendable supply channel includes one or more telescoping components that each form a fluid pathway between a supply line and the supply port(s). Similarly, in some embodiments, the extendable return channel includes one or more telescoping components that each form a fluid pathway between a return line and the return ports. The supply line can be fluidly coupled to a source of a purge gas (e.g., an argon gas tank or other suitable component) to provide the purge gas for the build chamber. The return line can be coupled to a vacuum component (or other suitable source of suction force) to remove gas from the build chamber.

In some embodiments, the chamber-purging system is coupled to an upper surface (e.g., the ceiling) of the build chamber. In such embodiments, the movable components of the chamber-purging system can move in an upward and downward direction between the first position and the second position. Said another way, when the chamber-purging system is in the first position, the recoater arm can move beneath the chamber-purging system. After spreading the layer of the powder, the movable components of the chamber-purging system can move downward and into the path of the recoater arm for the sintering process. After the new layer is sintered, the movable components of the chamber-purging system can move upward and out of (or partially out of and/or away from) the path of the recoater arm for the next layer to be spread.

For ease of reference, the additive manufacturing systems, and components thereof, are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that various components of the additive manufacturing systems can be moved to, and used in, different spatial orientations without changing the structure and/or function of the disclosed embodiments of the present technology.

### DESCRIPTION OF THE FIGURES

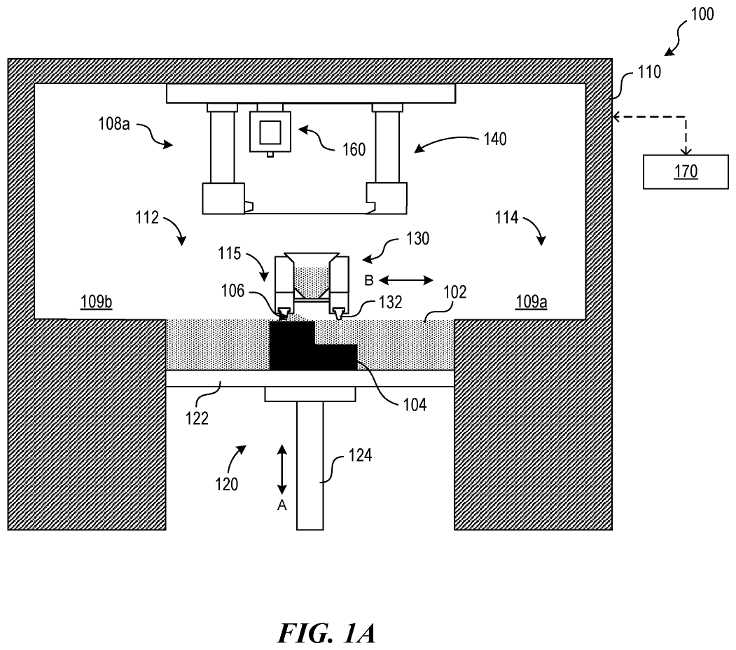

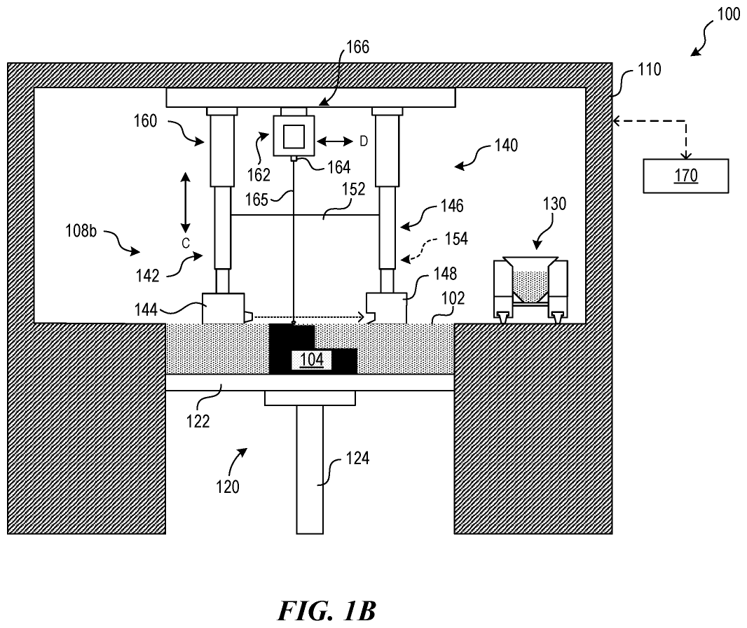

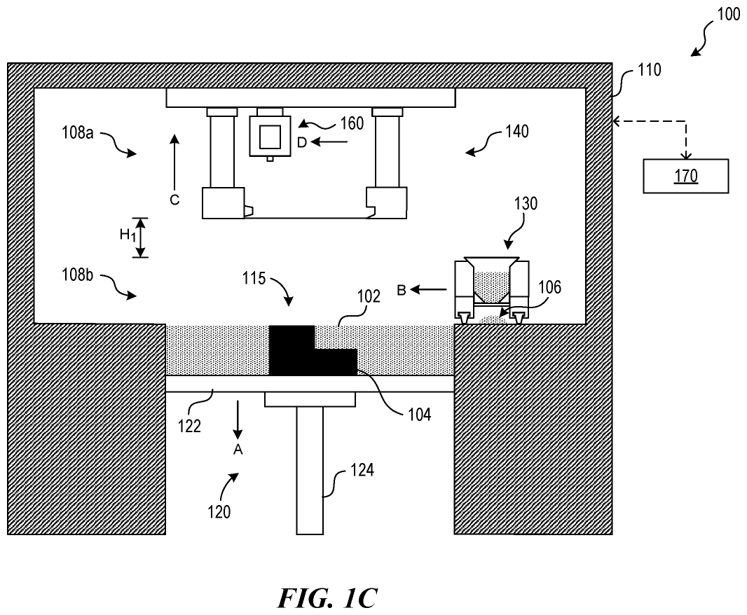

FIGS. 1A-1C are partially schematic, partially cross-sectional views of an additive manufacturing system 100 at various stages of a build process in accordance with some embodiments of the present technology. More specifically, FIG. 1A illustrates the additive manufacturing system 100 (“system 100”) during a powder spreading phase of the build process, FIG. 1B illustrates the system 100 during a powder-sintering phase of the build process, and FIG. 1C illustrates the system 100 during a resetting stage of the build process.

As illustrated in FIG. 1A, the system 100 can include a build chamber 110 (shown in cross-section). The build chamber 110 can include a central portion 112 and a peripheral portion 114 positioned laterally external to at least a portion of the central portion 112. The system 100 can also include a support system 120, a recoater arm 130, a chamber-purging system 140, and an energy beam system 160, each positioned within the build chamber 110. The system 100 can also include a controller 170 that is operably coupled to one or more other components of the system 100 to control the operation thereof.

In the illustrated embodiment, the support system 120 includes a support platform 122 and a first actuator 124 operably coupled to the support platform 122. The support platform 122 (e.g., a plate or other suitable support structure, sometimes also referred to herein as a “build platform”) extends across at least a portion of (or all of) the central portion 112, thereby defining an active build region 115 in the build chamber 110. The first actuator 124 is operably coupled to the support platform 122 to move the support platform 122 in a travel direction having upward and downward components along a first motion path A (e.g., along a z-axis). The recoater arm 130 includes one or more blades 132 (two shown in the illustrated embodiment) and moves along a second motion path B to spread a new layer of a powder 102 over the central portion 112 and a build object 104 therein.

During an additive manufacturing process (sometimes referred to herein as a “build process” and/or a “build”), the first actuator 124 can move the support platform 122 downward to make room for the new layer of the powder 102. The powder 102 can be (or include) a metallic powder, such as titanium-based powders, steel-based powders, stainless steel-based powders, aluminum-based powders, copper-based powders, nickel-based powders, and the like; various suitable ceramic powders; glass composites; and/or any other suitable material. After the support platform 122 moves downward, the recoater arm 130 (or another suitable component) can deposit a volume of new powder. Next, as illustrated in FIG. 1A, the recoater arm 130 can move in a lateral direction along the second motion path B (e.g., along the x-axis) over the central portion 112 from a first position 109a to a second position 109b. In some embodiments, the first and second positions 109a, 109b are on opposite sides of the build chamber 110 (e.g., moving from the peripheral portion 114 on the right of the central portion 112 to the peripheral portion 114 on the left of the central portion). As the recoater arm 130 moves, the blade(s) 132 spread the volume of the powder 102 in a thin, generally uniform layer over the central portion 112.

In some embodiments, spreading the new layer requires a trip forward and backward along the second motion path B (e.g., forward from the first position 109a to the second position 109b, then backward from the second position 109b to the first position 109a). In various embodiments, the system 100 can include a powder recycling system and/or a powder disposal system in the peripheral portion 114 to help manage excess powder at either end of the second motion path B. Purely by way of example, the system 100 can include a powder recycling system of the type disclosed in U.S. patent Application No. [Attorney Docket No. 034563.8052.US00] by Steve Craigen filed concurrently herewith, the entirety of which is incorporated herein by reference.

In some embodiments, the first actuator 124 moves the support platform 122 downward between the forward and backward motions of the recoater arm 130. In such embodiments, for example, the forward motion from the first position 109a to the second position 109b can spread a first portion of a powder layer, while the backward motion from the second position 109b to the first position 109a can spread the second portion of the powder layer. In other embodiments, the support platform 122 does not move between the forward and backward motion. In such embodiments, both motions can help to spread the entire powder layer over the active build region 115.

As illustrated in FIG. 1B, the chamber-purging system 140 can include an extendable supply channel 142 (sometimes also referred to herein as a “telescoping input channel,” an “extendable supply channel,” an “expandable input channel,” and/or the like) that includes and/or is fluidly coupled to one or more input nozzles 144 (one shown in schematically in FIG. 1B, also referred to herein as “supply nozzles”), as well as an extendable return channel 146 (sometimes also referred to herein as a “telescoping return channel,” an “expandable return channel,” an “extendable return channel,” a “suction channel,” and/or the like) that includes and/or is fluidly coupled to one or more suction receivers 148 (one shown in the illustrated embodiment, also referred to herein as “suction boxes,” “return chambers,” and/or “return ports”). In some embodiments, the input nozzle(s) 144 are integrated with the extendable supply channel 142 (e.g., formed integrally with and/or integrated with the extendable supply channel 142). In some embodiments, the input nozzle(s) 144 are coupled to a distal end of the extendable supply channel 142. Similarly, in some embodiments, the suction receiver(s) 148 are integrated with the extendable return channel 146 (e.g., formed integrally with and/or integrated with the extendable supply channel 142). In some embodiments, the suction receiver(s) 148 are coupled to a distal end of the extendable return channel 146.

After the powder layer has been fully deposited and spread over the central portion 112, the chamber-purging system 140 can move from a first position 108a (e.g., the position illustrated in FIG. 1A) that is spaced apart from (e.g., above, to the side of, and/or the like) the second motion path B (FIG. 1A) to a second position 108b that is at least partially within the second motion path B (e.g., the position illustrated in FIG. 1B). For example, as illustrated in FIG. 1B, the extendable supply channel 142 and the extendable return channel 146 can extend along a third motion path C to move the input nozzle(s) 144 and the suction receiver(s) 148, respectively, downward into the second position 108b.

Once the chamber-purging system 140 is in the second position 108b, the energy beam system 160 can sinter the powder 102 in a controlled pattern to form a build object 104. In the illustrated embodiment, the energy beam system 160 includes an energy beam head 162 carrying one or more energy beam sources 164 (one shown) and a track 166. The energy beam source(s) 164 direct one or more energy beams 165 toward the active build region 115 to sinter the powder 102 in the newly deposited layer onto the build object 104. In the illustrated embodiment, the track 166 allows the energy beam head 162 to move in a lateral direction along a fourth motion path D. The track 166 itself can move along a y-axis (transverse to the plane of FIG. 1A) to cover the active build region 115. In turn, the energy beam head 162 can use the movement to target appropriate regions of the active build region 115. Additionally, or alternatively, the energy beam head 162 can include one or more reflectors operably coupled to one or more servo motors to direct the energy beam(s) 165 toward the active build region 115.

In the second position 108b, the input nozzle(s) 144 and the suction receiver(s) 148 are positioned adjacent to the active build region 115. The input nozzle(s) 144 are positioned to direct a purge gas (e.g., an inert gas such as argon and/or any other suitable gas) over the active build region 115. The suction receiver(s) 148 are positioned to draw gas in (e.g., using a vacuum source) from a space above the active build region 115. As a result, the input nozzle(s) 144 and the suction receiver(s) 148 can create a flow of gas over the active build region 115 during a sintering process that is nearly laminar (or laminar), then remove the gas in the flow from the build chamber 110. The flow of gas over the active build region 115 can carry contaminants (e.g., smoke and other particulates generated by the sintering process). As a result, removing the gas in the flow can remove the contaminants from the build chamber, thereby reducing the number of errors caused by contaminants and/or impurities resulting from contaminants in the powder 102 and/or the build object 104.

The amount of contaminants that are removed by the chamber-purging system 140 can be related to how laminar the flow created over the active build region 115 is, the velocity of the flow, and/or a volume of the flow. Each of these factors can be controlled (e.g., improved and/or optimized) by adjusting the positioning of the input nozzle(s) 144 and the suction receiver(s) 148 and/or controlling the operation thereof. In some embodiments, the input nozzle(s) introduce a flow of purge gas at a flow rate that is below the flow rate of the suction receiver(s) 148. In one example, the nozzle flow is on the order of 15% to 50% of the suction flow. Other points of entry for the purge gas into the chamber can make up the difference between the nozzle flow and the suction flow. This approach can help remove particulates from the chamber as the nozzle flow entrains gas from around the build area and moves it to the suction. In another example, when the input nozzle(s) 144 and the suction receiver(s) 148 are positioned outside of the second travel path B (FIG. 1A), such as on peripheral walls of the build chamber 110, the space between the input nozzle(s) 144 and the suction receiver(s) 148 can prevent the flow from being laminar (or nearly laminar). As a result, fewer contaminants would be removed during the sintering process. Said another way, the chamber-purging system 140 improves the efficacy of the purging process by positioning the input nozzle(s) 144 and the suction receiver(s) 148 in relatively close proximity to the sintering site as compared to stationary components.

Relatedly, positioning the input nozzle(s) 144 and the suction receiver(s) 148 in the second position (e.g., adjacent to and on opposing sides of the active build region 115) creates a travel path for the flow between the input nozzle(s) 144 and the suction receiver(s) 148 that is almost entirely (or entirely) over the active build region 115. As a result, the length of the travel path is reduced (or minimized) toward a minimum length required to draw contaminants away from the active build area. Reducing the travel path, in turn, reduces the portion of the flow that is not captured by the suction receiver(s) 148 and therefore reduces the amount of contaminants that are not captured by the flow and not purged from the system compared to other systems. Such systems may have stationary components and/or components that are not positioned at least partially in the second travel path B (FIG. 1A) and are accordingly not as close to the active build region.

In some embodiments, the input nozzle(s) 144 and/or the suction receiver(s) 148 immediately above an upper surface of the powder 102 when the chamber-purging system 140 is in the second position 108b. In some embodiments, the input nozzle(s) 144 and/or the suction receiver(s) 148 can contact the upper surface, so long as the contact does not disturb the powder and disrupt the build process. Positioning components of the chamber-purging system 140 immediately above (or on) the upper surface can help simplify alignment and/or direct the flow of the purge gas closest to a primary source of contaminants (e.g., smoke from the sintering). In some embodiments, the input nozzle(s) 144 and/or the suction receiver(s) 148 are spaced apart from the upper surface of the powder 102 when the chamber-purging system 140 is in the second position 108b. Positioning components of the chamber-purging system 140 slightly above the upper surface can help generate a laminar flow (e.g., by reducing the effects of drag from the powder on the flow). In various embodiments, the input nozzle(s) 144 and/or the suction receiver(s) 148 can be between about 0.005 inches above the upper surface and about 0.8 inches above the upper surface when the chamber-purging system 140 is in the second position 108b; or between about 0.040 inches above the upper surface and about 0.25 inches above the upper surface when the chamber-purging system 140 is in the second position 108b. In some embodiments, the height is dependent on the powder being sintered (e.g., contaminants from lighter powders can concentrate farther from the upper surface of the powder 102 than contaminants from heavier powders). As discussed in more detail below, it can be advantageous to reduce the travel time and distance between the “raised” position (e.g., FIG. 1A) and the “lowered” position (e.g., FIG. 1B) of the chamber-purging system 140. For example, reducing the travel time can help reduce overall manufacturing time.

In the illustrated embodiment, the extendable supply channel 142 and the extendable return channel 146 each comprise telescoping components that extend in a linear direction (e.g., in an upward and downward direction and/or in a lateral direction). In various other embodiments, the extendable supply channel 142 and/or the extendable return channel 146 can include an accordion component, a coiled component, another suitable linearly expanding component, and/or any other suitable components that facilitate movement between the first position 108a and the second position 108b while allowing gas flow.

In the embodiment illustrated in FIG. 1B, the chamber-purging system 140 includes sidewalls 152 (one illustrated, one omitted by the partial cross-section) extending parallel to the plane of FIG. 1B between the input nozzle(s) 144 and the suction receiver(s) 148. The sidewalls 152 can be positioned such that, when the chamber-purging system 140 is in the second position 108b, the sidewalls bound longitudinal sides of the active build region 115. In this position, the sidewalls 152 can help maintain the flow along the illustrated travel path by blocking the purge gas from exiting laterally from the sides of the flow. Additionally, or alternatively, the sidewalls can help create an entrainment that directs purge gases (and other gases) elsewhere in the chamber into the suction receiver(s) 148. Additionally, or alternatively, the chamber-purging system 140 can include a backwall 154 positioned at least partially behind the suction receiver(s) 148 with respect to the travel path of the flow. The backwall 154 extends orthogonal to the plane of FIG. 1B and, in the illustrated embodiment, is generally aligned with the telescoping return channel 146. Similar to the sidewalls 152, the backwall 154 can help maintain the flow along the illustrated travel path by at least partially blocking the purge gas from exiting from the flow over the suction receiver(s) 148. As a result, the sidewalls 152 and/or the backwall 154 can help improve the efficacy of the purging process by helping promote a laminar flow between the input nozzle(s) 144 and the suction receiver(s) 148.

As illustrated in FIG. 1C, after the energy beam system 160 sinters the powder 102 in the active build region 115, the build chamber 110 can reset and prepare to add a new layer to the build object. For example, the support platform 122 moves downward along the first motion path A to make room for a new layer of the powder 102. The recoater arm 130 deposits a spreadable volume of powder 106. The chamber-purging system 140 moves from the second position 108b (see also FIG. 1B) to the first position 108a along the third motion path C to clear the second motion path B for the recoater arm 130. The energy beam system 160 can return to a baseline position along the fourth motion path D.

After the support platform 122 moves downward and the chamber-purging system 140 returns to the first position 108a, the recoater arm 130 can spread a new layer of the powder 102 over the active build region 115 to begin repeating the process described above. These steps can be repeated any number of times until the build object 104 is complete. After the build object 104 is completed, a user can remove the build object 104, any unused powder (e.g., non-sintered powder) can be recovered, and the first actuator 124 can move the support platform 122 upward to reset the support system 120 for the next build.

In some embodiments, moving the chamber-purging system 140 from the second position 108b (see also FIG. 1B) to the first position 108a includes positioning the input nozzle(s) 144 and/or the suction receiver(s) 148 (FIG. 1B) just above a clearance height for the recoater arm 130. For example, in the first position 108a, the chamber-purging system 140 can be positioned between about 0.25 inches and about 0.5 inches above an upper surface of the recoater arm 130. This position can help ensure that the recoater arm 130 has sufficient room to spread a new layer of the powder 102 while reducing (or minimizing) the time needed to reset the build chamber 110 by reducing the distance the chamber-purging system 140 is moved. In embodiments where the process is repeated thousands, or tens of thousands, of times, the low clearance can save hours of operational time.

As further illustrated in FIGS. 1A-1C, referred to collectively, the system 100 can include a controller 170 (shown schematically) programmed with instructions for directing the operations and motions carried out by the support system 120, the recoater arm 130, the chamber-purging system 140, the energy beam system 160, and/or any other suitable components of the system 100. Accordingly, the controller 170 can include a processor, memory, and input/output devices, any of which can include a computer-readable medium containing instructions for performing some or all of the tasks described herein. In some embodiments, the controller 170 is configured to receive a computer-generated model of the build object 104 and to control the operations and motions of the components of the system 100 to manufacture the build object 104 based on the computer-generated model. In some embodiments, the controller 170 is configured to receive feedback information about the additive manufacturing process from, for example, various sensors, cameras, and the like that can be located within the build chamber 110. The controller 170 can also be configured to modify/direct operations and motions of the various components of the system 100 based at least in part on the received feedback information.

For example, information from sensors can indicate that a shortfill occurred in the most recent layer. In this example, the controller 170 can be configured to receive the information and control the recoater arm 130 to rectify the shortfill. In a specific, non-limiting example, the controller 170 can cause the recoater arm 130 to deposit and spread an additional volume of powder over the central portion to rectify the shortfill. As a result, the controller 170 can help avoid various shortcomings associated with a shortfill (e.g., gaps and/or other errors in the build object 104). In another example, the sensors can indicate that the recoater arm 130 is depositing an excessive amount of powder that is building up in the build chamber 110 (e.g., in the peripheral portion 114, between the blades 132 of the recoater arm 130, and/or the like). In this example, the controller 170 can be configured to receive the information and control the recoater arm 130 to deposit smaller volumes of powder in the following layers, thereby reducing (or eliminating) negative effects of excess build-up (e.g., the excess powder can impede the recoater arm 130 along the second motion path B). By detecting insufficient and excessive volumes of the powder 102, the controller 170 can improve the quality of the build object 104 resulting from the build process.

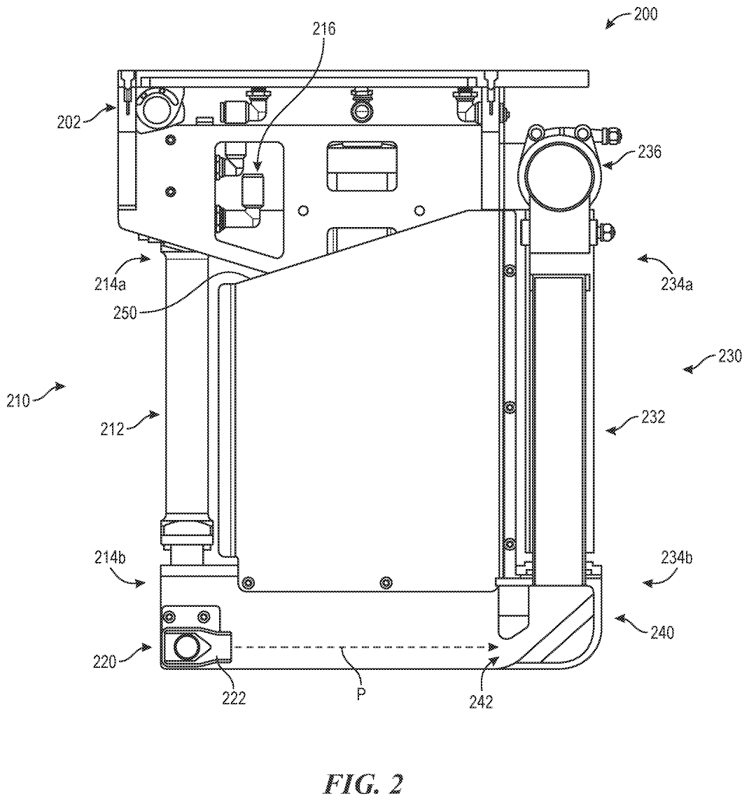

FIG. 2 is a partially cross-sectional side view of a portion of a chamber-purging system 200 configured in accordance with some embodiments of the present technology. As illustrated, the chamber-purging system 200 shown in FIG. 2 is generally similar to the chamber-purging system 140 described above with reference to FIG. 1A-1C. For example, the chamber-purging system 200 includes an extendable supply channel 210 having one or more input nozzles 220 (one shown in the illustrated embodiment), an extendable return channel 230 having one or more suction receivers 240 (one shown in the illustrated embodiment), and sidewalls 250 (one shown in the illustrated cross-section).

In the illustrated embodiment, the extendable supply channel 210 includes a telescoping component 212 that has a first end 214a and a second end 214b. The first end 214a is fluidly coupled to one or more supply lines 216 (one is labeled in the illustrated embodiment) to receive an input of the purge gas (e.g., from a storage within the build chamber 110 (FIG. 1A) and/or operably coupled to the build chamber 110). The second end 214b is operably coupled to the input nozzle 220 to position the input nozzle 220 during a build process and to deliver the purge gas during a purging phase of the build process. For example, as discussed above, the extendable supply channel 210 can extend (and retract), via expansion (and contraction) of the telescoping component 212, to move the input nozzle 220 into (and out of) the pathway of the recoater arm and adjacent to (and spaced apart from) the active build region.

Similarly, the extendable return channel 230 includes a telescoping component 232 that has a first end 234a and a second end 234b. The first end 234a is fluidly coupled to one or more return lines 236 (one is labeled in the illustrated embodiment) that is, in turn, couplable to a suction component a vacuum source, or other suitable suction device. The second end 234b is operably coupled to the suction receiver 240 to position the suction receiver 240 during a build process and to apply a suction force during the purging phase. For example, as discussed above, the extendable return channel 230 can extend (and retract), via expansion (and contraction) of the telescoping component 232, to move the suction receiver 240 into (and out of) the pathway of the recoater arm and adjacent to (and spaced apart from) the active build region.

As further illustrated in FIG. 2, the input nozzle 220 includes an input opening 222 that is directed toward a return opening 242 on the suction receiver 240. These positions allow the input nozzle 220 to direct the purge gas outward toward the return opening 242 along a path P and the suction receiver 240 to draw in the purge gas along the path P. As a result, the chamber-purging system 200 can create a laminar (or near laminar) flow between the input nozzle 220 and the suction receiver 240. Further, the extendable supply channel 210 and extendable return channel 230 can position the input nozzle 220 and the suction receiver 240 (respectively) adjacent to the active build region. As a result, the chamber-purging system 200 can use the laminar (or near laminar) flow between the input nozzle 220 and the suction receiver 240 to remove contaminants from the build chamber 110 (FIG. 1A) more effectively than stationary components.

In the embodiment illustrated in FIG. 2, each of the components of the chamber-purging system 200 is carried by a frame 202. The frame 202 can be fixed to the build chamber 110 (FIG. 1A) and/or carried by any other suitable component therein. For example, the frame 202 can be carried by a track system attached to an upper surface (e.g., a ceiling) of the build chamber 110 (FIG. 1A) that allows the chamber-purging system 200 to be moved (e.g., translated) in one or more lateral directions (e.g., in an x-y plane) while the extendable supply channel 210 and extendable return channel 230 extend in a vertical direction (e.g., along a z-axis). The translation of the chamber-purging system 200 in lateral directions can allow the input nozzle 220 and the suction receiver 240 to be positioned closer together that in non-translating systems. For example, the input nozzle 220 and the suction receiver 240 can provide a relatively small space for the energy beam system to sinter the powder and translate as needed to sinter the powder layer.

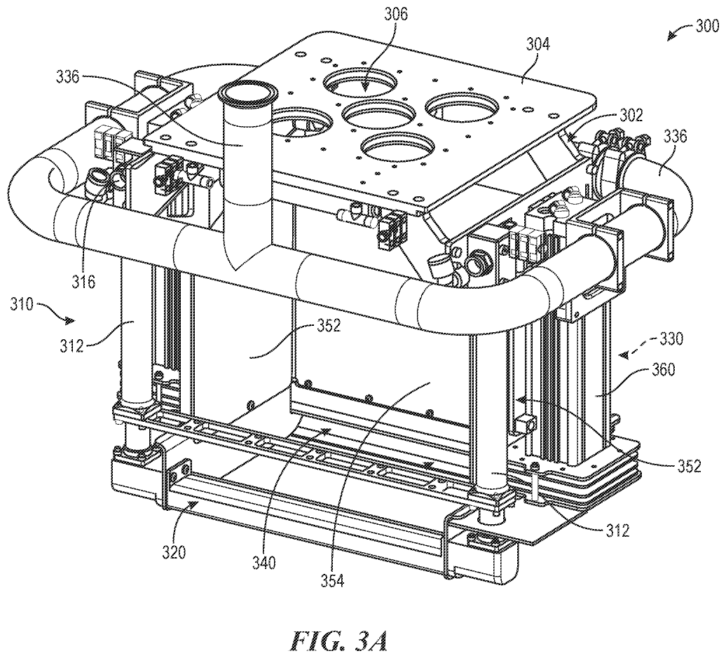

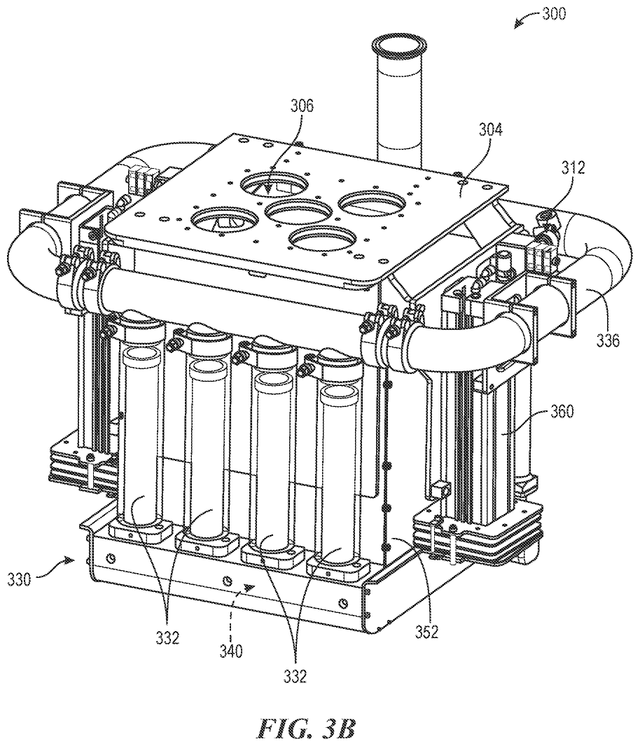

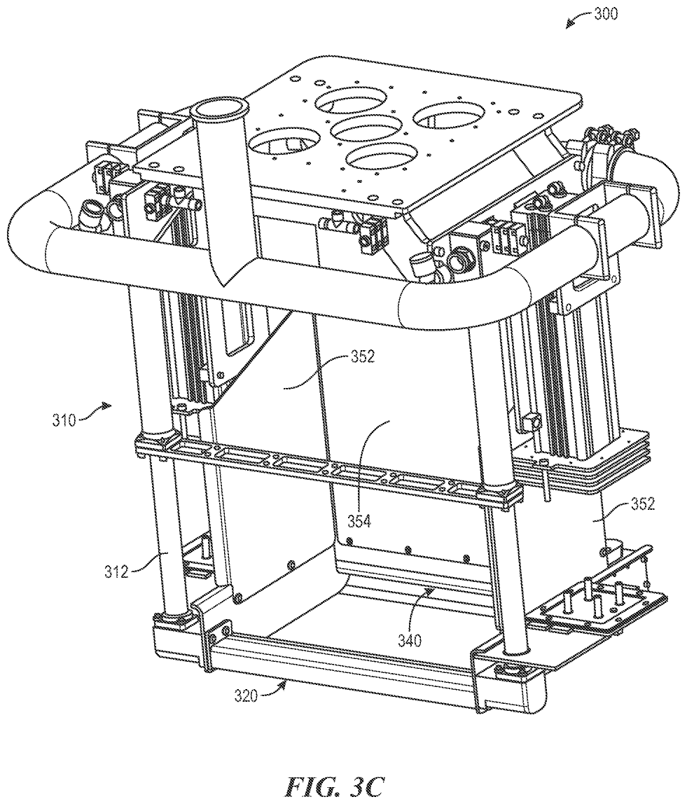

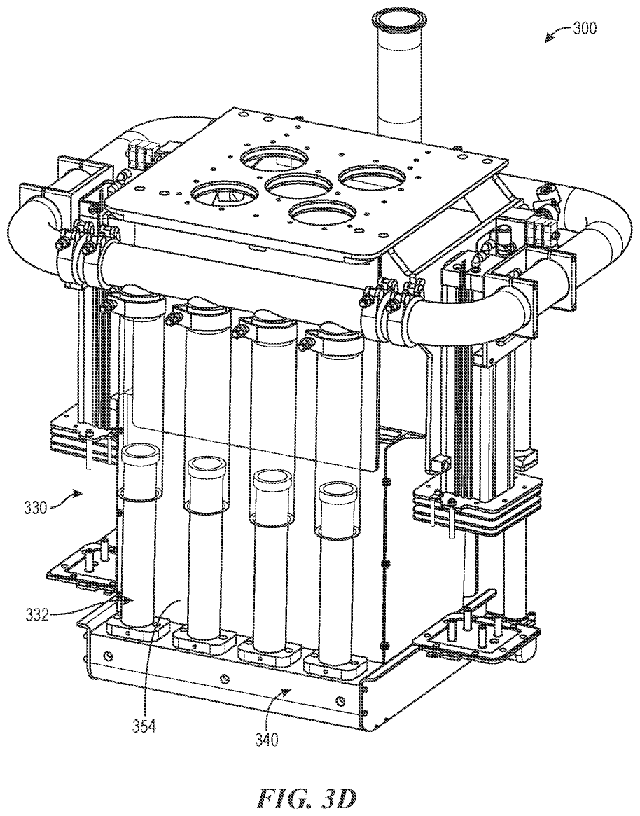

FIGS. 3A and 3B are isometric front and rear views, respectively, of a chamber-purging system 300 configured in a retracted position in accordance with some embodiments of the present technology. As illustrated in FIG. 3A, the chamber-purging system 300 is generally similar to the chamber-purging system 200 described above with reference to FIG. 2. For example, the chamber-purging system 300 includes an extendable supply channel 310, one or more input nozzles 320, an extendable return channel 330, a suction receiver 340, sidewalls 352, and a backwall 354.

In the illustrated embodiment, however, the extendable supply channel 310 includes multiple telescoping supply components 312 that are operably coupled between supply lines 316 and the input nozzle(s) 320. The multiple telescoping supply components 312 can help stabilize the chamber-purging system 300. Additionally, or alternatively, the multiple telescoping supply components 312 can help improve the distribution of the purge gas at each of the input nozzle(s) 320 (e.g., rather than concentrated around one input nozzle). In turn, the distribution can help improve the likelihood that a laminar flow is established between the input nozzle(s) 320 and the suction receiver 340.

Similarly, as illustrated in FIG. 3B, the extendable return channel 330 includes multiple telescoping return components 332 that are each coupled between return lines 336 and the suction receiver 340. The multiple telescoping return components 332 can help stabilize the chamber-purging system 300. Additionally, or alternatively, the multiple telescoping return components 332 can help distribute the suction force throughout the suction receiver (e.g., rather than concentrated around a single coupling point between the extendable supply channel 310 and the suction receiver 340). As a result, the multiple telescoping return components 332 can help improve the likelihood that a laminar flow is established between the input nozzle(s) 320 and the suction receiver 340. Further, in the ill

As further illustrated in FIGS. 3A and 3B, referred to collectively, the chamber-purging system 300 can also include a frame 302 that couples the chamber-purging system 300 to a suitable structure in the build chamber 110 (FIG. 1A). In the illustrated embodiment, the frame 302 includes an upper plate 304 that has energy beam openings 306. The upper plate 304 can be coupled to an upper surface (e.g., the ceiling) of the build chamber 110 (FIG. 1A). The energy beam openings 306 provide space for the energy beam system 160 (FIG. 1A) to direct an energy beam through and/or be positioned in.

In the embodiment illustrated in FIGS. 3A and 3B, the chamber-purging system 300 also includes stabilizing structures 360 coupled to the sidewalls 352. The stabilizing structures 360 can help maintain the chamber-purging system 300 in the illustrated retracted configuration (e.g., by locking the sidewalls 352 in place). Additionally, or alternatively, the stabilizing structures 360 can help control the movement of the chamber-purging system 300 while transitioning to an extended configuration (e.g., as illustrated in FIGS. 3C and 3D). For example, the stabilizing structures 360 can include one or more gas cylinders that extend and retract to help control the movement of the chamber-purging system 300. In some embodiments, the stabilizing structure(s) 360 move both the input nozzle(s) 320 and the suction receiver 340 together and in other embodiments, these components can move in an uncoupled manner, as is further identified below.

FIGS. 3C and 3D are isometric front and rear views, respectively, of the chamber-purging system 300 configured in an extended position in accordance with some embodiments of the present technology. To reach the extended position, each of the telescoping supply components 312 moves from a first state (e.g., a retracted position) to a second state (e.g., the extended position), thereby moving the input nozzle(s) 320 in a downward direction. Similarly, each of the telescoping return components 332 moves from a first state (e.g., a retracted position) to a second state (e.g., the extended position), thereby moving the suction receiver 340 in a downward direction. In some embodiments, the telescoping supply components 312 and the telescoping return components 332 each move at the same time (or nearly simultaneously). In some such embodiments, the movement of the telescoping supply components 312 and the telescoping return components 332 is linked. In some embodiments, the telescoping supply components 312 and the telescoping return components 332 move independently and/or at different times. The independent movement can allow, for example, the suction receiver 340 to be used for alternative gas-removal purposes independent from the input nozzle(s) 320.

As further illustrated in FIGS. 3C and 3D, the movement of the telescoping supply components 312 and the telescoping return components 332 can also move the sidewalls 352 and/or the backwall 354. For example, the sidewalls 352 can be coupled between the distal ends of the telescoping supply components 312 and the telescoping return components 332 (e.g., coupled to the input nozzle(s) 320 and the suction receiver 340, attached directly to the distal ends, and/or coupled in any other suitable manner). As a result, the movement of the telescoping supply components 312 and the telescoping return components 332 moves each of the input nozzle(s) 320, the suction receiver 340, and the sidewalls 352. Similarly, as best illustrated in FIG. 3D, the backwall 354 can be coupled to the distal ends of the telescoping return components 332 and/or the suction receiver 340. As a result, the movement of the telescoping return components 332 moves both the suction receiver 340 and the backwall 534.

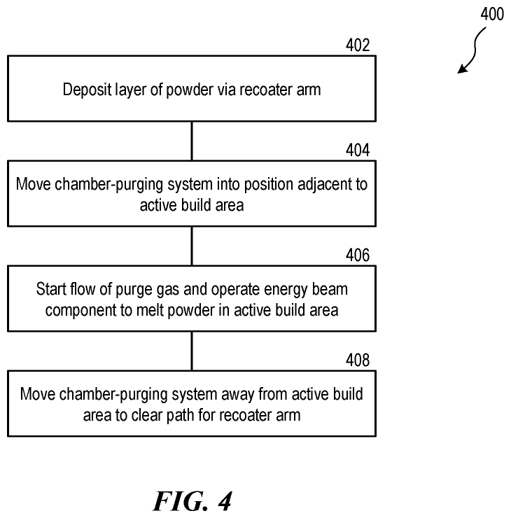

FIG. 4 is a flow diagram of a process 400 for operating an additive manufacturing system in accordance with further embodiments of the present technology. The process 400 can be implemented by the controller 170 of FIG. 1A (or another suitable controller) to control various components of the system 100. It will be understood that the process 400 can be repeated any suitable number of times during a relevant build process to construct ab build object.

The process begins at block 402 with starting a flow of purge gas (e.g., an inert gas such as argon) through the chamber-purging system and depositing a layer of powder over the central portion (or active build region) of a build chamber using a recoater arm. Starting the flow of the purge gas can include inputting the purge gas (e.g., via the extendable input channel) and retrieving gas (e.g., via the extendable return channel). As discussed above with reference to FIG. 1A, the powder deposition phase can include depositing a suitable volume of powder between two blades of the recoater arm, then moving the recoater arm forward and backward over the central portion (e.g., from right to left then left to right along the second motion path B of FIG. 1A). The powder deposition phase can spread a generally level (or level) and generally uniform (or uniform) new layer of powder over the support surface and/or previous layers. For the powder deposition phase to spread a generally level, uniform layer, the motion path of the recoater arm (e.g., the second motion path B of FIG. 1A) must be clear from obstruction from other components of the build chamber.

At block 404, the process 400 includes moving a chamber-purging system from a first position to a second position. The first position can be clear of the motion path of the recoater arm, but too removed from the active build region to effectively remove contaminants (e.g., smoke) from the build chamber when the powder is sintered. In contrast, the second position can be at least partially within the motion path of the recoater arm and, as a result, closer to the active build region (or immediately adjacent to the active build region). In the second position, the chamber-purging system can effectively remove contaminants from the build chamber, but obstruct the recoater arm if not later moved out of the way. Once the chamber-purging system is in the second position, the input and retrieval of the purge gas via the chamber-purging system can create a consistent, laminar (or nearly laminar) flow of the purge gas over the active build area.

At block 406, the process 400 includes operating an energy beam system. The Operating the energy beam system can cause the energy beam system to sinter powder in the active build region. As the energy beam system sinters the powder, byproducts such as smoke and other contaminants are generated from the melting powder layer. Without a consistent flow of the purge gas, these byproduct contaminants can settle on the recently sintered material and/or on the surrounding powder (that may be sintered next). Once settled, the byproducts can cause errors in the build object. For example, the contaminants can prevent sequential layers in the build object from fully bonding. The consistent, laminar (or nearly laminar) flow of the purge gas provided by the chamber-purging system, in the second position, can remove at least a portion of the contaminants. As a result, the chamber-purging system, in the second position, can reduce (or eliminate) the errors in the build object caused by byproducts of the sintering process. As discussed above, the operation of the energy beam system can be controlled (e.g., by the controller 170 of FIG. 1A) according to a model for the build object at the current layer.

Once the new layer has been fully sintered, at block 408, the process 400 includes moving the chamber-purging system from the second position to the first position (e.g., thereby resetting the build chamber). Once in the first position, the chamber-purging system is out of the motion path for the recoater arm and the process 400 can return to block 402 to deposit the next layer of powder and continue to form the build object.

### Examples

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. An additive manufacturing system, comprising:
a build chamber having an active build region;
a support platform positioned in the active build region and movable in a travel direction having upward and downward components;
an energy beam source positioned to direct an energy beam at the active build region during a build;
a recoater arm positioned in the build chamber and movable in a lateral direction along a travel path above the active build region to spread one or more layers of a powder over the active build region during the build; and
a chamber-purging system positioned in the build chamber and having at least a portion that is movable between a first position outside the travel path and a second position within the travel path.

2. The additive manufacturing system of clause 1, wherein the chamber-purging system comprises:
a telescoping supply channel having one or more supply ports and fluidly couplable to a source of an inert gas to deliver gas to the build chamber, the telescoping supply channel being movable between a first retracted state and a first extended state to move the one or more supply ports between the first position the second position; and
a telescoping return channel having a return port and fluidly couplable to a vacuum component to remove gas from the build chamber, the telescoping return channel being movable between a second retracted state and a second extended state to move the return port between the first position the second position.

3. The additive manufacturing system of clause 2 wherein the lateral direction is a first lateral direction, and wherein the return port is spaced apart from one or more supply ports in a second lateral direction.

4. The additive manufacturing system of any of clauses 2 and 3 wherein the one or more supply ports and the return port are spaced apart to define, at least in part, a flow path therebetween, wherein the chamber-purging system further comprises sidewalls extending along lateral sides of the flow path, and wherein the sidewalls are positioned to impede a flow of the gas introduced into the build chamber away from the flow path.

5. The additive manufacturing system of any of clauses 2-4 wherein the one or more supply ports and the return port are spaced apart to define a flow path therebetween wherein the chamber-purging system further comprises a backwall operably coupled to the return port and the telescoping return channel to move with the return port as the telescoping return channel expands, and wherein the backwall is positioned to impede a flow of the gas introduced into the build chamber away from the flow path.

6. The additive manufacturing system of any of clauses 1-5 wherein the chamber-purging system is fluidly couplable to a source of argon to purge the build chamber while the energy beam source is in operation.

7. The additive manufacturing system of any of clauses 1-6 wherein the chamber-purging system is movable in an upward and downward direction between the first position and the second position, and wherein, in the first position, the chamber-purging system is positioned to allow the recoater arm to move beneath the chamber-purging system.

8 The additive manufacturing system of any of clauses 1-7 wherein the chamber-purging system comprises one or more supply ports and a return port, and wherein, in the second position, each of the one or more supply ports and the return port are positioned immediately above a most recent layer of the powder deposited by the recoater arm.

9. A method for manufacturing an object in an additive manufacturing system, the method comprising:
depositing, via a recoater arm, a layer of powder over an active build area within a build chamber of the additive manufacturing system;
moving at least a portion of a chamber-purging system toward the active build area from a first position to a second position, wherein moving the at least a portion of the chamber-purging system to the second position includes positioning a supply component and a return component adjacent to opposing sides of the active build area;
operating the chamber-purging system, including directing an inert gas out of the supply component and removing gas from the build chamber via the return component;
while operating the chamber-purging system, delivering an energy beam to the active build area to melt a portion of the layer of powder in the active build area; and
after delivering the energy beam to the active build area, moving the chamber-purging system from the second position to the first position, including by positioning the supply component and the return component outside a motion pathway of the recoater arm.

10. The method of clause 9 wherein the layer is a first layer, and wherein the method further comprises depositing, via the recoater arm, a second layer of powder over the active build area after moving the chamber-purging system into the first position.

11. The method of any of clauses 9 and 10 wherein moving the at least a portion of the chamber-purging system to the second position further includes positioning the supply component and the return component immediately adjacent to an upper surface of the layer of the powder.

12. The method of any of clauses 9-11 wherein operating the chamber-purging system while delivering the energy beam to the active build area further comprises removing contaminants from the active build area via a flow of the inert gas from the supply component to the return component.

13. A chamber-purging system for an additive manufacturing system, the chamber-purging system comprising:
an extendable supply channel having a supply port and fluidly couplable to a source of an inert gas to deliver the inert gas to a build chamber of the additive manufacturing system through the supply port, the extendable supply channel being movable between a first retracted state and a first extended state, wherein:
   in the first retracted state, the extendable supply channel positions the supply port outside of a movement path of a recoater arm in the additive manufacturing system; and
   in the first extended state, the extendable supply channel positions the supply port at least partially within the movement path of the recoater arm; and
an extendable return channel having a return port and fluidly coupled to a suction component to remove gas from the build chamber through the return port, the extendable return channel movable between a second retracted state and a second extended state, wherein:
   in the second retracted state, the extendable return channel positions the return port outside of the movement path of the recoater arm; and
   in the second extended state, the extendable return channel positions the return port at least partially within the movement path of the recoater arm.

14 The chamber-purging system of clause 13 wherein the supply port and the return port are spaced apart to establish a purge gas pathway between the supply port and the return port as the inert gas is, at least in part, delivered to the build chamber, and wherein the chamber-purging system further comprises:
a first sidewall operably coupled to the extendable supply channel and the extendable return channel and extending between the supply port and the return port on a first lateral side of the purge gas pathway, the first sidewall positioned to create a first barrier to the inert gas along the purge gas pathway; and
a second sidewall operably coupled to the extendable supply channel and the extendable return channel and extending between the supply port and the return port on a first lateral side of the purge gas pathway, the second sidewall positioned to create a second barrier to the inert gas along the purge gas pathway.

15. The chamber-purging system of any of clauses 13 and 14 wherein the supply port and the return port are spaced apart to establish a purge gas pathway between the supply port and the return port as gas is delivered to the build chamber, and wherein the chamber-purging system further comprises a backwall operably coupled to the extendable return channel and positioned to create a barrier to the inert gas along the purge gas pathway behind the return port.

16. The chamber-purging system of any of clauses 13-15 wherein the supply port comprises a plurality of supply ports positioned to direct the inert gas toward the return port when the extendable supply channel is in the first extended state and the extendable return channel is in the second extended state.

17 The chamber-purging system of any of clauses 13-16 wherein the extendable return channel comprises a plurality of extendable components spaced apart along a lateral axis, and wherein the supply port comprises an input component with an opening extending along the lateral axis.

18. The chamber-purging system of any of clauses 13-17 wherein the inert gas includes one or more of Nitrogen or Argon.

19. The chamber-purging system of any of clauses 13-18 wherein:
in the first extended state, the extendable supply channel positions the supply port adjacent to an upper surface of a layer of powder most recently deposited on an active build surface in the additive manufacturing system; and
in the second extended state, the extendable return channel positions the return port adjacent to the upper surface of the layer of powder most recently deposited on the active build surface.

20 The chamber-purging system of any of clauses 13-19 wherein, in the first extended state, the extendable supply channel positions the supply port adjacent to a first side of a build object in the additive manufacturing system, and wherein, in the second extended state, the extendable return channel positions the return port adjacent to a second side of the build object opposite the first side.

### CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and “about” are used herein to mean within at least within 10 percent of a given value, limit, and/or requirement. Purely by way of example, an approximate ratio means within a ten percent of the given ratio.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In some embodiments, for example, components of the chamber-purging system can be divided, combined, and/or controlled independently. In a specific example, the telescoping input and return channels can be combined into a single telescoping component with input channels coupled to the nozzles and return channels coupled to the suction receivers. In another specific example, the telescoping components can be controlled and/or positioned independently (e.g., allowing the telescoping input channel to extend independent from the position of the telescoping return channel). In yet another specific example, the telescoping input and/or return channels can be divided into multiple telescoping components. In yet another specific example, the sidewalls and/or the backwall of the chamber-purging system can be coupled to a telescoping component independent from the telescoping input and return channels. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. An additive manufacturing system, comprising:
a build chamber having an active build region;
a support platform positioned in the active build region and movable in a travel direction having upward and downward components;
an energy beam source positioned to direct an energy beam at the active build region during a build;
a recoater arm positioned in the build chamber and movable in a lateral direction along a travel path above the active build region to spread one or more layers of a powder over the active build region during the build; and
a chamber-purging system positioned in the build chamber and having at least a portion that is movable between a first position outside the travel path and a second position within the travel path.

2. The additive manufacturing system of claim 1, wherein the chamber-purging system comprises:
a telescoping supply channel having one or more supply ports and fluidly couplable to a source of an inert gas to deliver gas to the build chamber, the telescoping supply channel being movable between a first retracted state and a first extended state to move the one or more supply ports between the first position the second position; and
a telescoping return channel having a return port and fluidly couplable to a vacuum component to remove gas from the build chamber, the telescoping return channel being movable between a second retracted state and a second extended state to move the return port between the first position the second position.

3. The additive manufacturing system of claim 2 wherein the lateral direction is a first lateral direction, and wherein the return port is spaced apart from one or more supply ports in a second lateral direction.

4. The additive manufacturing system of claim 2 wherein the one or more supply ports and the return port are spaced apart to define, at least in part, a flow path therebetween, wherein the chamber-purging system further comprises sidewalls extending along lateral sides of the flow path, and wherein the sidewalls are positioned to impede a flow of the gas introduced into the build chamber away from the flow path.

5. The additive manufacturing system of claim 2 wherein the one or more supply ports and the return port are spaced apart to define a flow path therebetween wherein the chamber-purging system further comprises a backwall operably coupled to the return port and the telescoping return channel to move with the return port as the telescoping return channel expands, and wherein the backwall is positioned to impede a flow of the gas introduced into the build chamber away from the flow path.

6. The additive manufacturing system of claim 1 wherein the chamber-purging system is fluidly couplable to a source of argon to purge the build chamber while the energy beam source is in operation.

7. The additive manufacturing system of claim 1 wherein the chamber-purging system is movable in an upward and downward direction between the first position and the second position, and wherein, in the first position, the chamber-purging system is positioned to allow the recoater arm to move beneath the chamber-purging system.

8. The additive manufacturing system of claim 1 wherein the chamber-purging system comprises one or more supply ports and a return port, and wherein, in the second position, each of the one or more supply ports and the return port are positioned immediately above a most recent layer of the powder deposited by the recoater arm.

9. A method for manufacturing an object in an additive manufacturing system, the method comprising:
depositing, via a recoater arm, a layer of powder over an active build area within a build chamber of the additive manufacturing system;
moving at least a portion of a chamber-purging system toward the active build area from a first position to a second position, wherein moving the at least a portion of the chamber-purging system to the second position includes positioning a supply component and a return component adjacent to opposing sides of the active build area;
operating the chamber-purging system, including directing an inert gas out of the supply component and removing gas from the build chamber via the return component;
while operating the chamber-purging system, delivering an energy beam to the active build area to melt a portion of the layer of powder in the active build area; and
after delivering the energy beam to the active build area, moving the chamber-purging system from the second position to the first position, including by positioning the supply component and the return component outside a motion pathway of the recoater arm.

10. The method of claim 9 wherein the layer is a first layer, and wherein the method further comprises depositing, via the recoater arm, a second layer of powder over the active build area after moving the chamber-purging system into the first position.

11. The method of claim 9 wherein moving the at least a portion of the chamber-purging system to the second position further includes positioning the supply component and the return component immediately adjacent to an upper surface of the layer of the powder.

12. The method of claim 9 wherein operating the chamber-purging system while delivering the energy beam to the active build area further comprises removing contaminants from the active build area via a flow of the inert gas from the supply component to the return component.

13. A chamber-purging system for an additive manufacturing system, the chamber-purging system comprising:
an extendable supply channel having a supply port and fluidly couplable to a source of an inert gas to deliver the inert gas to a build chamber of the additive manufacturing system through the supply port, the extendable supply channel being movable between a first retracted state and a first extended state, wherein:
in the first retracted state, the extendable supply channel positions the supply port outside of a movement path of a recoater arm in the additive manufacturing system; and
in the first extended state, the extendable supply channel positions the supply port at least partially within the movement path of the recoater arm; and
an extendable return channel having a return port and fluidly coupled to a suction component to remove gas from the build chamber through the return port, the extendable return channel movable between a second retracted state and a second extended state, wherein:
in the second retracted state, the extendable return channel positions the return port outside of the movement path of the recoater arm; and
in the second extended state, the extendable return channel positions the return port at least partially within the movement path of the recoater arm.

14. The chamber-purging system of claim 13 wherein the supply port and the return port are spaced apart to establish a purge gas pathway between the supply port and the return port as the inert gas is, at least in part, delivered to the build chamber, and wherein the chamber-purging system further comprises:
a first sidewall operably coupled to the extendable supply channel and the extendable return channel and extending between the supply port and the return port on a first lateral side of the purge gas pathway, the first sidewall positioned to create a first barrier to the inert gas along the purge gas pathway; and
a second sidewall operably coupled to the extendable supply channel and the extendable return channel and extending between the supply port and the return port on a first lateral side of the purge gas pathway, the second sidewall positioned to create a second barrier to the inert gas along the purge gas pathway.

15. The chamber-purging system of claim 13 wherein the supply port and the return port are spaced apart to establish a purge gas pathway between the supply port and the return port as gas is delivered to the build chamber, and wherein the chamber-purging system further comprises a backwall operably coupled to the extendable return channel and positioned to create a barrier to the inert gas along the purge gas pathway behind the return port.

16. The chamber-purging system of claim 13 wherein the supply port comprises a plurality of supply ports positioned to direct the inert gas toward the return port when the extendable supply channel is in the first extended state and the extendable return channel is in the second extended state.

17. The chamber-purging system of claim 13 wherein the extendable return channel comprises a plurality of extendable components spaced apart along a lateral axis, and wherein the supply port comprises an input component with an opening extending along the lateral axis.

18. The chamber-purging system of claim 13 wherein the inert gas includes one or more of Nitrogen or Argon.

19. The chamber-purging system of claim 13 wherein:
in the first extended state, the extendable supply channel positions the supply port adjacent to an upper surface of a layer of powder most recently deposited on an active build surface in the additive manufacturing system; and
in the second extended state, the extendable return channel positions the return port adjacent to the upper surface of the layer of powder most recently deposited on the active build surface.

20. The chamber-purging system of claim 13 wherein, in the first extended state, the extendable supply channel positions the supply port adjacent to a first side of a build object in the additive manufacturing system, and wherein, in the second extended state, the extendable return channel positions the return port adjacent to a second side of the build object opposite the first side.
